(19) United States
(12) Patent Application Publication
(10) Pub. No.: US 2016/0277537 A1
(43) Pub. Date: Sep. 22, 2016

(54) METHOD AND DEVICE FOR THE MANAGEMENT OF APPLICATIONS

(71) Applicant: TELEFONAKTIEBOLAGET L M ERICSSON (PUBL), Stockholm (SE)

(72) Inventors: Hongxin LIANG, Stockholm (SE); Dimitri MAZMANOV, Stockholm (SE)

(73) Assignee: TELEFONAKTIEBOLAGET L M ERICSSON (PUBL), Stockholm (SE)

(21) Appl. No.: 15/035,070

(22) PCT Filed: Nov. 8, 2013
(86) PCT No.: PCT/SE2013/051318

§ 371 Date: May 6, 2016

(51) Int. Cl. H04L 29/08; G06F 3/0482; H04M 1/725

(52) U.S. Cl. CPC H04L 67/34; H04M 1/72522; H04M 1/72525; H04L 67/18; G06F 3/0482

(57) ABSTRACT

A method by a user terminal are a related user terminal are disclosed for managing applications that are executable by the user terminal. Folder information is generated that defines folders of applications. Action rule information is generated which defines, for each of the folders, an action to be performed on the folder and a rule that initiates performance of the action. A first one of the rules is determined to be satisfied. A first one of the folders is selected which is associated with the satisfied first rule. Applications are identified which are missing from a memory of the user terminal that are members of the selected first folder. The identified applications are downloaded from an application storage node via a network to the memory of the user terminal. Related methods and network nodes are disclosed for managing which applications are downloaded to user terminals.

### TECHNICAL FIELD

The present disclosure relates to communication networks and, more particularly, to managing the distribution and operation of applications on user terminals.

### BACKGROUND

Increasingly, users install a wide range of applications (also commonly referred to as “apps”) on a wide range of user terminals, such as cellular telephones, tablet computers, and personal computers. Such applications may be downloaded from a “marketplace” or “application store,” which may be managed by as a single organization, typically by a cellular telephone service provider or device manufacturer. Accordingly, managing entity is able to serve applications (both free and paid) for download to user terminals.

The downloading process typically involves a user executing an application store application and entering a key word that is to be used to search for a desired application. Alternatively, the user may select among buttons representing categories of applications, such as “games” or “featured.” In either case, the user is presented with a list of applications from which to choose.

The limited amount of memory storage space that is available within user terminals can create an undesired burden on users to manage which individual applications reside on a user terminal. Users can delete individual applications to free-up space in memory to allow downloading of a new application. A listing of applications that are on the user terminal may be backed-up to the application store (e.g., a cloud network node). Applications that have been previously downloaded but back-up to the cloud network node may be viewable as a list for consideration to allow a user to select individual applications to be re-downloading from the cloud network node. In view of some users downloaded for testing or use of hundreds or thousands of applications over time, it can place an undesirable/unreasonable burden on a user to remember the functionality of individual applications and any similar or complementary functionality provided by different particular applications which the user may have earlier found to be beneficial as a collective group on the user terminal.

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

It may therefore be an object to address at least some of the above mentioned disadvantages and/or to provide improved management of applications that are executable on user terminals.

One embodiment is directed to a method by a user terminal for managing applications that are executable by the user terminal. The method includes generating folder information that defines folders of the applications. Action rule information is generated which defines, for each of the folders of applications, an action to be performed on the folder of applications and a rule that initiates performance of the action. A first one of the rules is determined to be satisfied. A first one of the folders of the applications is selected which is associated with the satisfied first one of the rules. Applications are identified which are missing from a memory of the user terminal that are members of the selected first one of the folders of the applications. The identified applications are downloaded from an application storage node via a network to the memory of the user terminal.

A potential advantage of this and further embodiments is that a user can group applications into folders, and define action rules that cause defined actions to be performed on particular ones of the folders of applications when the associated actions rules are satisfies. Thus, for example, a user can group one set of applications into a first folder and another set of applications into a second folder, and can define action rules that cause the applications in the first folder to be deleted from the user terminal (e.g., to free-up memory space) and the applications in the second folder are to be downloaded from a network node to the user terminal based on arriving in a defined city. The user may similarly define rules that cause the applications in the second folder to be deleted from the user terminal (e.g., to free-up memory space) and the applications in the first folder are to be downloaded from the network node to the user terminal based on departing the defined city or arriving at another defined location. Such downloading and deleting operation may be performed automatically without intervention of the user or the user may be queried to allow these operations.

Another embodiment is directed to a method by at least one network node, which includes a folder ID repository node of a distributed computing system, for managing which applications are downloaded to user terminals. The method includes receiving folder information via the network from a plurality of user terminals. The folder information defines folders of applications that the user terminals can select among for downloading. A query is received from one of the user terminals that identifies a search criteria for searching among the folders of applications defined by the folder information. One of the folders of applications is identified that satisfies the search criteria. A list of the applications within the identified one of the folders of applications is communicated to the one of the user terminals.

Related user terminals and network nodes are disclosed.

Other methods and apparatuses according to embodiments of the invention will be or become apparent to one with skill in the art upon review of the following drawings and detailed description. It is intended that all such additional methods and apparatuses be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 is a block diagram of an application management system that is configured to operate according to some embodiments;

FIGS. 2-6 illustrate example user interfaces on a user terminal for generating folders of applications and defining associated actions and rules for managing the folders of applications, according to some embodiments;

FIG. 7 is a data flow diagram illustrating example operations and methods for managing applications in folders responsive to associated action rules, according to some embodiments;

FIGS. 8-14 and are flowcharts of operations and methods performed by a user terminal to generate folders of applications and defining associated action rules for managing applications within the folders of applications, according to some embodiments;

FIGS. 15-17 are flowcharts of operations and methods performed by one or more network nodes of an application management system to manage applications within folders provided to a user terminal, according to some embodiments;

FIG. 18 is a block diagram of an example network node in an application management system configured to operate according to some embodiments.

### DETAILED DESCRIPTION

The invention will now be described more fully hereinafter with reference to the accompanying drawings, in which embodiments of the invention are shown. This invention may, however, be embodied in many different forms and should not be construed as limited to the embodiments set forth herein.

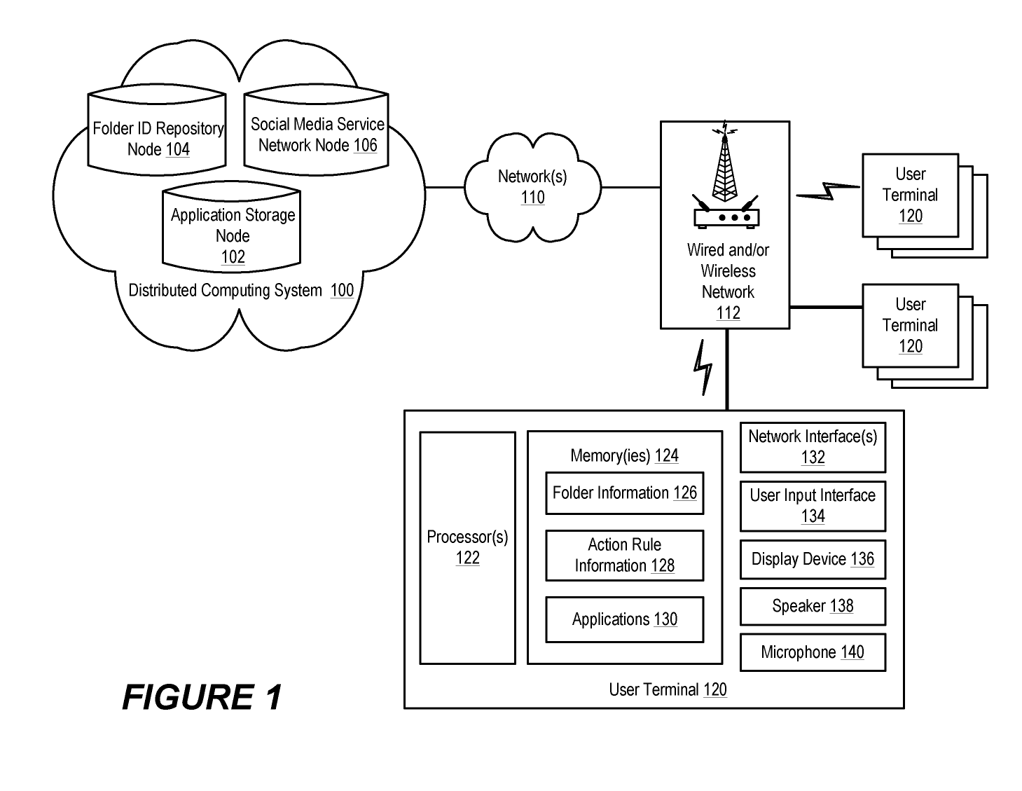

FIG. 1 is a block diagram of an application management system that is configured to operate according to some embodiments. The system includes a plurality of user terminals 120 that communicate through a wired and/or wireless network 112 and one or more data networks 110 (e.g., wide area networks, Internet) with a distributed computing system 100 containing an application storage node 102, a social media service network node 106, and a folder ID repository node 104. Although the folder ID repository node 104, the application storage node 102, and the social media service network node 106 are illustrated in FIG. 1 as separate network nodes, some or all of the functionality of two or more of these nodes may be combined within a same network node in accordance with some embodiments.

The user terminals 120 download applications via the data network 110 and wired/wireless network 112 from the application storage node 102, which may correspond to the Android® marketplace or Apple iTunes® application store, to one or more memories 124 of the user terminals 120. The user terminals 120 can be any type of electronic devices that can download and execute such applications, and can include, but are not limited to, fixed/mobile/transportable terminals (e.g., smart phones, tablet computers, desktop computers), televisions, appliances, and/or gaming consoles.

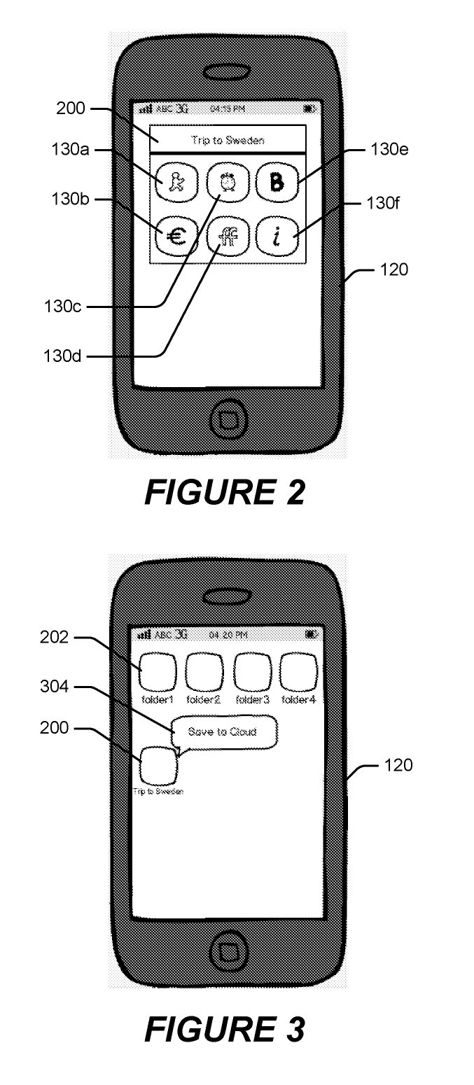

Various embodiments disclosed herein enable users to group applications into folders and, for each of the folders, to define an action that is to be performed on the collective group of applications within the associated folder, and a rule that initiates performance of the action. Some of these embodiments are now explained with regard to FIGS. 2-6, which illustrate non-limiting example user interfaces that may be displayed on a display device 136 of the user terminal 120 for generating folders of applications and defining associated actions and triggering rules for managing applications within the folders of applications.

Referring to the embodiment of FIG. 2, the user has controlled the user terminal 120 (e.g., through a user input interface 134 via conventional or new operations disclosed herein) to group six different applications 130a-f into one shared folder 200 that is designated (e.g., named “Trip to Sweden”) for use during a upcoming trip by the user to Sweden. One or more of the applications 130a-f may presently reside in the memory 124 of the user terminal 120 or may reference corresponding application(s) that can be downloaded from the application storage node 102.

Referring to the embodiment of FIG. 3, the user has similarly controlled the user terminal 120 to group applications within four other folders (e.g., “folder1”, “folder2”, “folder3”, and “folder4”). Moreover, in accordance with one embodiment, the user can select a folder (e.g., by touch selecting the folder and maintaining the selection for a threshold time) to cause a user selectable action 304 (e.g., “save to cloud”) to be displayed, which the user can select to save the folder information (identify the folder name and the collection of applications in the folder) in the folder ID repository node 104 for future reference and enable downloading of the applications identified by the folder information as a collective group from the application storage node 102. The user may thereby, for example, perform an action to delete the folder named “Trip to Sweden” to cause the applications 130a-f to be deleted from the memory 124, and thereafter operate the user terminal 120 to perform another action that causes the folder named “Trip to Sweden” and the applications contained therein to be collectively downloaded to the memory 124 of the user terminal 120.

A potential advantage is that by allowing a user to save the folder information in the folder ID repository node 104, and thereafter allowing the user to obtain the folder information from the folder ID repository node 104 and cause the collection of applications within the folder to be downloaded together from the application storage node 102, the user's management of which applications reside on the user terminal 120 can be simplified. Moreover, in accordance with further embodiments herein, the user can define these and other actions that operate on all applications with a folder and rules that cause the actions to be performed.

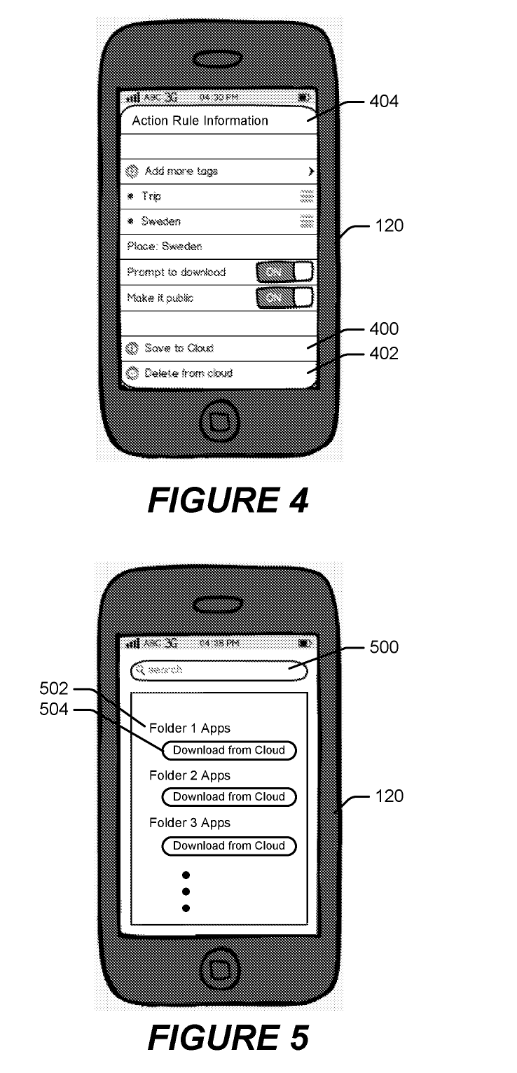

Referring to the embodiment of FIG. 4, the user terminal 120 displays a user interface that allows the user to generate action rule information 404 that defines an action to be performed on the collection of applications 130a-f in the “Trip to Sweden” folder, and a rule that initiates performance of the action. In the example, the user has defined with the information 404 an action that causes the user terminal 120 to prompt the user for permission to download (“prompt to download”) the folder of applications defined as “Trip to Sweden” and, when permission is granted, causes the folder of applications 130a-f to be automatically downloaded from the application storage node 102 without further action of the user. The user further defines through the information 404 a rule that initiates performance of that action based on where the user terminal 120 is located, such as a rule that is satisfied when the user terminal 404 becomes located at a defined location (Sweden).

The user can also select an interface setting (“make it public”) that is displayed to make the name of the folder and its defined applications 130a-f public, which causes the user terminal 120 to generate a message containing an address link that can be used by other user terminals 120 to retrieve at least a portion of the folder information from the folder ID repository node 104, and communicate the message to other user terminals 120 and/or to the social media service network node 106 (e.g., post the message for users of the other terminal 120 to read) for retrieval by the other user terminals 120. Through related operations, when the user makes a folder public, the folder ID repository node 104 changes the visibility of the folder from a private privilege setting to a public privilege setting. The private privilege setting may be a default setting for all folders saved to the folder ID repository node 104, and the private privilege setting can prevent other users from seeing the folder and its listing of applications when those users conduct searches. In contrast, the public privilege setting allows other users to identify the folder, such as through a search operation and/or using an address link that has been posted to social media or provided through a message to the other users, and access the listing of applications provided by the folder.

The user can select an interface setting “save to cloud” that is displayed to cause the folder information (identity of the folder name and the collection of applications in the folder) to be saved in the folder ID repository node 104 for future reference and enable downloading of the applications identified by the folder information as a collective group from the application storage node 102. The user can similarly select an interface setting “delete from cloud” that is displayed to cause the folder information (identity of the folder name and the collection of applications in the folder) to be deleted from the folder ID repository node 104, which prevents future reference therefrom.

Referring to the embodiment of FIG. 5, the user terminal 120 displays another user interface that allows the user to touch select one of a plurality of indicia “Download from Cloud” 504 that are displayed adjacent to the respective names 502 of folders of applications that the user has generated, to cause the user terminal 120 to download the collection of applications grouped in “Folder1”, “Folder2”, “Folder3”, etc, that is associated with the touch selected indicia. A search input interface 500 is displayed that allows a user to enter search criteria that can be used to search within the folder ID repository node 104 to identify folders of applications that have attributes which satisfy the search criteria. The folder attributes may include, but are not limited to, folder names, application names within each folder, operational functionality provided by one or more applications within a folder, ratings by the user or by other users for a folder and/or for one or more applications within a folder, etc.

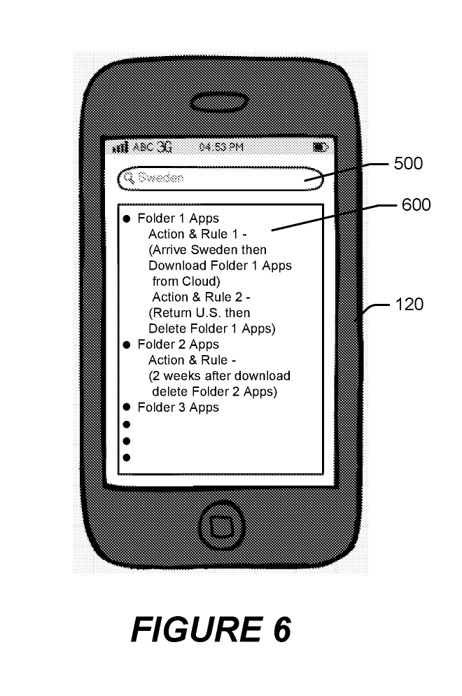

Referring to the embodiment of FIG. 6, the user terminal 120 displays another user interface 600 that identifies the names of three folders of applications, and further identifies one or more actions associated rules for carrying out the actions. For example, the “Folder1 Apps” folder has a defined action for downloading the applications within the folder from the cloud (e.g., application storage node 102) to the memory 124 in response to a defined rule being satisfied for arriving in Sweden (e.g., displayed as “arrive Sweden then download folder one apps from cloud”). The “Folder1 Apps” folder has another defined action for deleting the applications within the folder from the memory 124 in response to a defined rule of two weeks having passed after the applications were downloaded to the memory 124 (e.g., displayed as “2 weeks after download delete Folder 2 Apps”).

Thus, some non-limiting examples of rules can include, a first one of the rules defining a geographic area, where the rule is determined to be satisfied based on determining that the user terminal 120 has moved to the geographic area. Another one of the rules can define an elapsed time, and the rule is determined to be satisfied based on determining that the elapsed time has elapsed since the associated folders of application was downloaded from the application storage node 102 to the memory 124 of the user terminal 120. Still another one of the rules can define a geographic area, and the rule is determined to be satisfied based on determining that the user terminal 120 has returned to the geographic area after being determined to have left the geographic area.

Referring again to FIG. 1, the example user terminal 120 includes a processor 122, memory 124, network interface 132, the user input interface 134, the display device 136, may further include a speaker 138 and/or a microphone 140. The network interface 132 include one or more wired and/or wireless communication circuits, which may include but are not limited to a cellular transceiver, a wired network interface, a wireless local area network transceiver, a Bluetooth transceiver, and/or a near field communication transceiver.

The processor 122 may include one or more data processing circuits, such as a general purpose and/or special purpose processor (e.g., microprocessor and/or digital signal processor), which may be collocated or distributed across one or more data networks (e.g., network 110). The processor 122 is configured to execute computer program instructions from applications 130 (e.g., applications 130a-f of FIG. 2) and an application manager 125 in the memory 124, described below as a computer readable medium. The application manager 125 manages action that are performed on the folders of applications based on the folder information 126 and action rule information 128 that is defined in the memory 124 and/or which is obtained from the folder ID repository node 104 to perform some or all of the operations and methods for one or more of the embodiments disclosed herein, such as the embodiments of FIGS. 1-17.

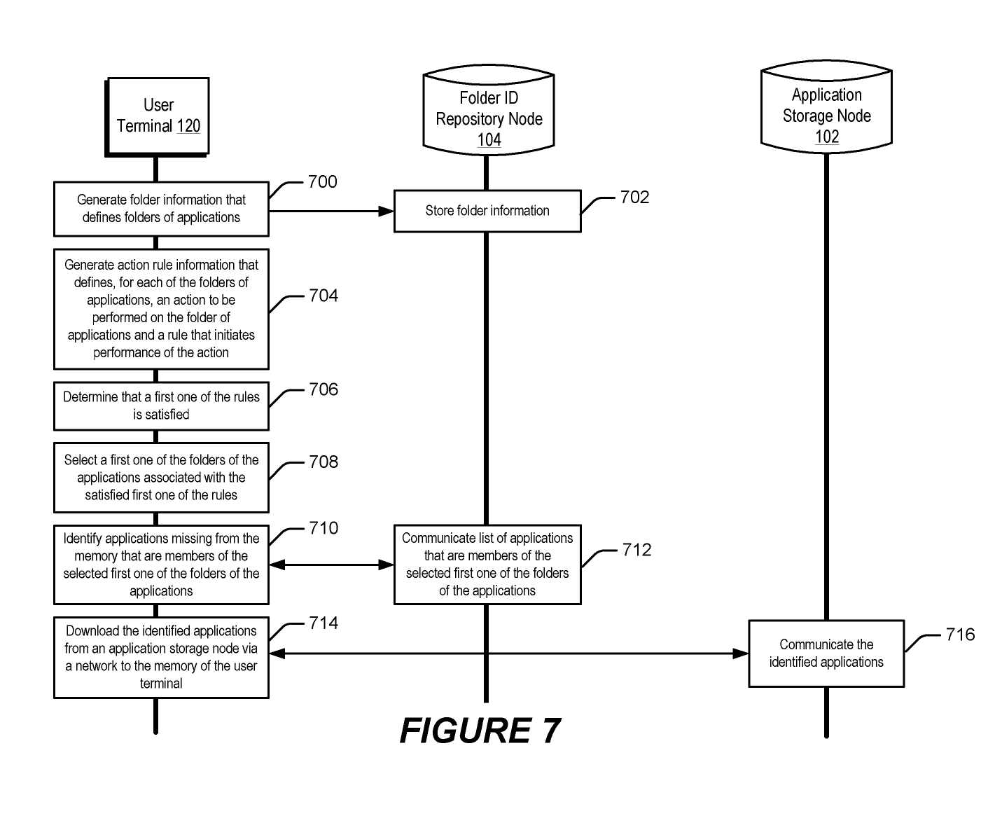

These and other more general embodiments are now described with reference to the embodiment of FIG. 7, which is a data flow diagram illustrating example operations and methods for managing applications in folders defined in the memory 124 responsive to associated actions and rules. The user terminal 120 generates 700 folder information that defines folders of the applications (e.g., responsive to input from the user). The user terminal 120 generates 704 action rule information that defines, for each of the folders of applications, an action to be performed on the folder of applications and a rule that initiates performance of the action (e.g., responsive to further input from the user). The user terminal 120 determines 706 that a first one of the rules (“first rule”) is satisfied, and, based thereon, selects 708 a first one of the folders of the applications (“selected first folder”) associated with the satisfied first rule. The user terminal 120 identifies 710 applications missing from a memory 124 of the user terminal 120 that are members of the selected first folder. The identification 710 may be carried out at a folder-by-folder level by determining that the selected first folder is missing from the memory 124, or may be carried out at an application-by-application level identifying for each of the applications within the selected first folder whether that particular application already resides in the memory 124. The user terminal 120 downloads 714 the identified applications from the application storage node 102 (which communicates 716 the applications), via the network 110, to the memory 124 of the user terminal 120.

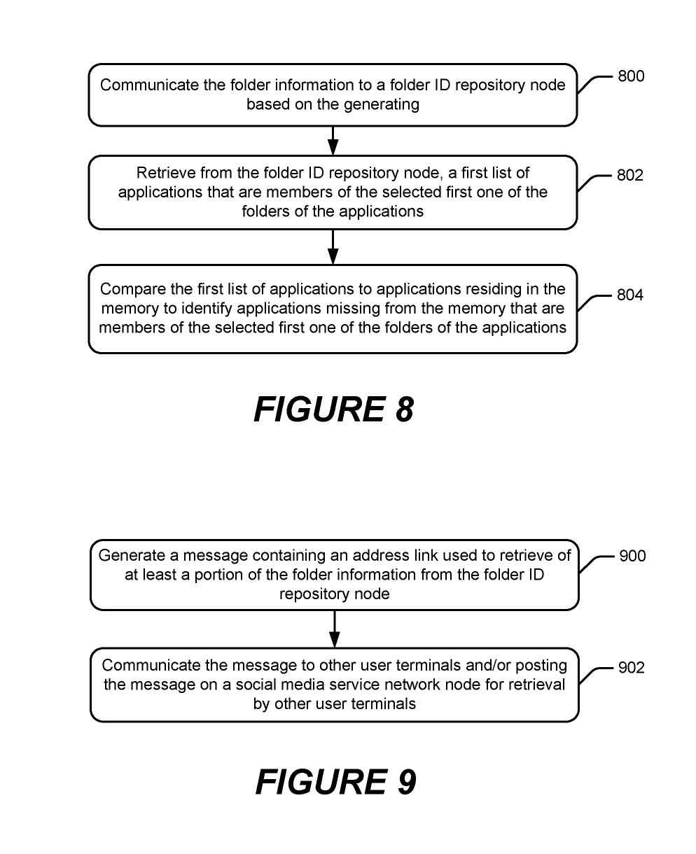

Referring to the embodiments of FIGS. 7 and 8, the user terminal 120 may communicate 800 the folder information to the folder ID repository node 104 via the network 110 for storage 702 and for future retrieval by the user terminal 120 and/or by other user terminals 120 (e.g., such as via the social media service network node 106 and/or via a message sent to the other user terminals 120).

A potential advantage is that storing the folder information in the folder ID repository node 104 may be particularly useful to enable retrieval of that information after the folder and application therein have been deleted from the memory 120 for the user terminal 120.

To identify 710 applications missing from the memory 124 of the user terminal 120 that are members of the selected first folder, the user terminal 120 can retrieve 712/802 from the folder ID repository node 104 via the network, a first list of applications that are members of the selected first folder, and can compare 804 the first list of applications to applications residing in the memory 124 of the user terminal 120 to identify applications missing from the memory 124 of the user terminal 120 that are members of the selected first folder.

As explained above, folder information identifying folder names and application contents of folders can be shared with other user terminals 120. Referring to the embodiment of FIG. 9, the mobile terminal 120 can generate 900 a message containing an address link used to retrieve of at least a portion of the folder information from the folder ID repository node 104, and can communicate 902 the message to the other user terminals 120 and/or post the message on the social media service network node 106 for retrieval by the other user terminals 120.

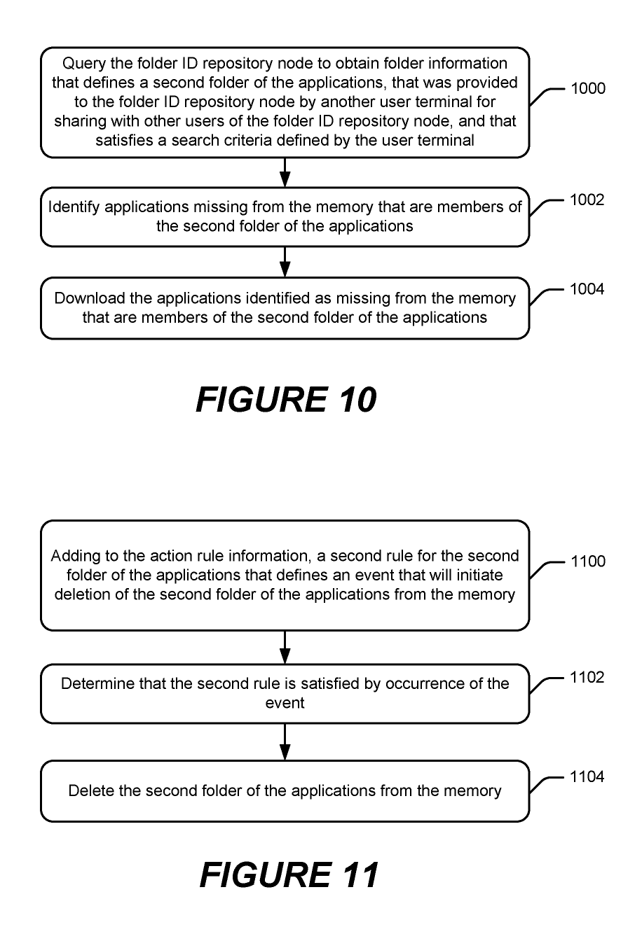

Referring to the embodiment of FIG. 10, the mobile terminal 120 may perform the sharing by querying 1000 the folder ID repository node 104 to obtain folder information that defines a second folder of the applications (“second folder”), that was provided to the folder ID repository node 104 by another user terminal 120 for sharing with other users of the folder ID repository node 104, and that satisfies a search criteria defined by the user terminal 120. Thus, for example, the mobile terminal 120 may send a query containing user defined search criteria to the folder ID repository node 104 to identify folders containing applications that satisfy the search criteria. The mobile terminal 120 identifies 1002 applications missing from the memory 124 of the user terminal 120 that are members of the second folder (e.g., perform the folder-by-folder basis or an application-by-application basis), and can download 1004, via the network 110 to the memory 124 of the user terminal 120, the applications identified as missing from the memory 124 of the user terminal 120 that are members of the second folder.

Referring to the embodiment of FIG. 11, the user terminal 120 adds 1100 a second rule for the second folder that defines an event that will initiate deletion of the second folder (the applications grouped in the second folder) from the memory 124 of the user terminal 120. The user terminal 120 determines 1102 that the second rule is satisfied by occurrence of the event, and deletes 1104 the second folder from the memory 124 of the user terminal 120.

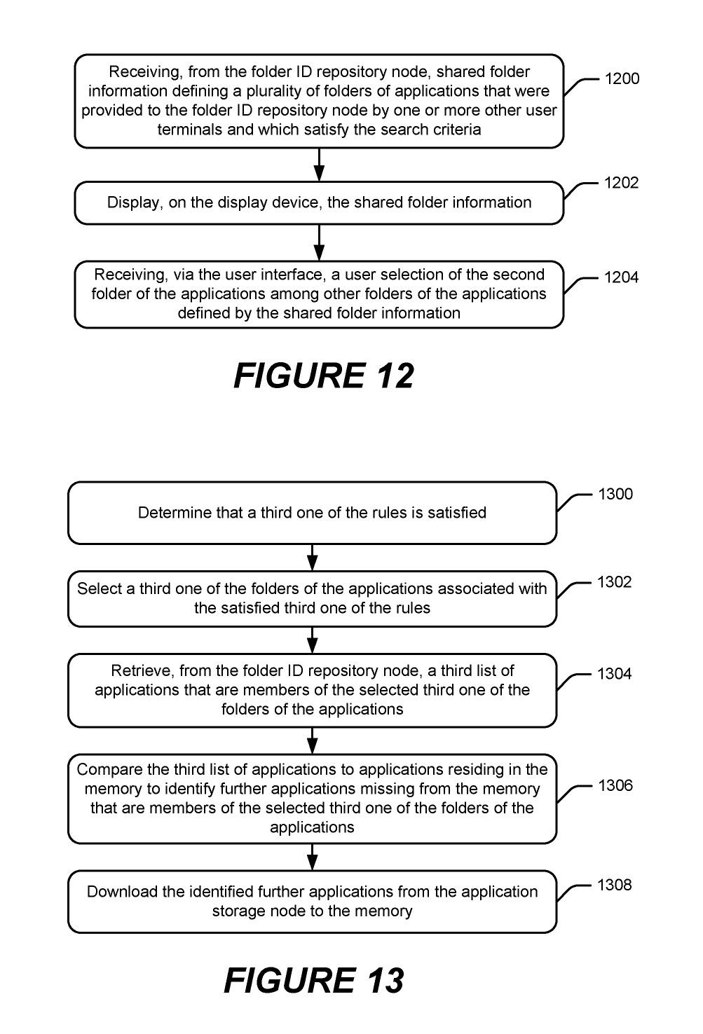

Referring to the embodiments of FIGS. 10 and 12, the step of querying 1000 the folder ID repository node 104 to obtain folder information that defines the second folder, the user terminal 120 can include receiving 1200, from the folder ID repository node 104, shared folder information defining a plurality of folders of applications that were provided to the folder ID repository node 104 by one or more other user terminals (120) and which satisfy the search criteria. The user terminal 120 can display 1202, on the display device 136, the shared folder information, and receive 1204, via the user input interface 134, a user selection of the second folder among other folders of the applications defined by the shared folder information.

Referring to the embodiment of FIG. 13, the user terminal 120 can determine 1300 that a third one of the rules (“third rule”) is satisfied and, based thereon, selecting 1302 a third one of the folders of the applications (“selected third folder”) associated with the satisfied third rule. The user terminal 120 can retrieve 1304, from the folder ID repository node 104 via the network 110, a third list of applications that are members of the selected third folder, compare 1306 the third list of applications to applications residing in the memory 124 of the user terminal 120 to identify further applications missing from the memory 124 that are members of the selected third folder, and download 1306 the identified further applications from the application storage node 102 via the network 110 to the memory 124.

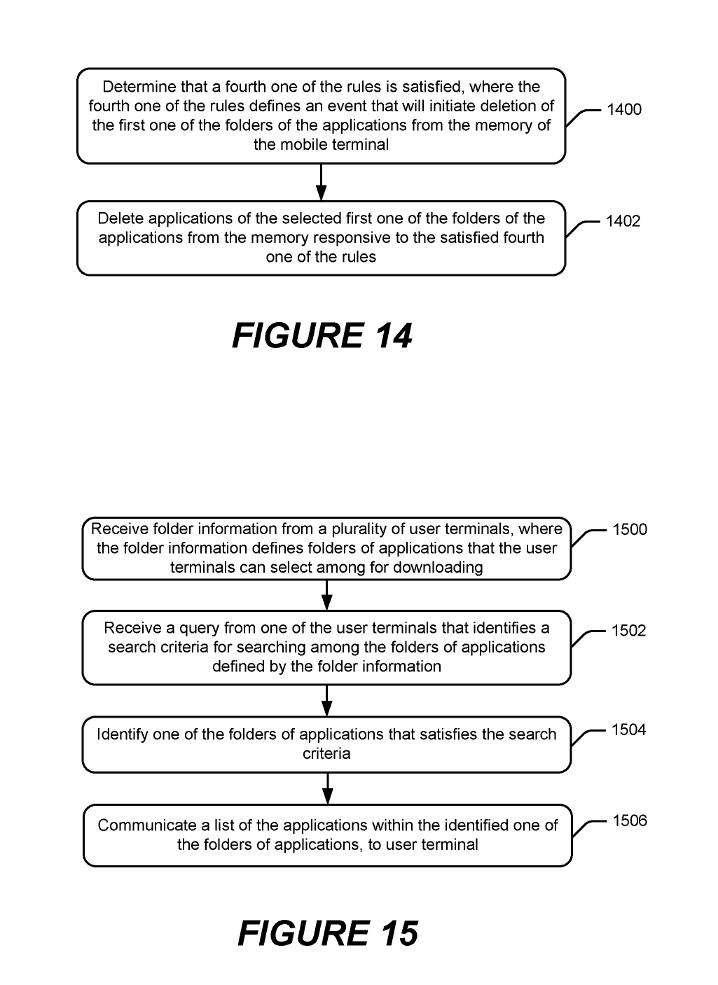

Referring to the embodiment of FIG. 14, the user terminal 120 can determine 1400 that a fourth one of the rules is satisfied, where the fourth one of the rules defines an event that will initiate deletion of the first folder (the applications grouped in the first folder) from the memory 124 of the user terminal 120 and, based thereon, delete 1402 applications of the selected first folder from the memory 124 of the user terminal 120 responsive to the satisfied fourth one of the rules.

Corresponding operations and methods that can be performed by the folder ID repository node 104 and/or another network node to manage applications are downloaded to user terminals 120 and enable sharing of folders information between user terminals 120, will now be described in the context of the embodiments of FIGS. 15-17. For ease of reference, the example operations are described in the context of being performed by the folder ID repository node 104 although they may be for performed at least partially or entirely by another network node.

Referring to the embodiment of FIG. 15, folder information is received 1500 via the network 110 from a plurality of user terminals 120, where the folder information defines folders of applications that the user terminals 120 can select among for downloading. A query is received 1502 from one of the user terminals 120 that identifies a search criteria for searching among the folders of applications defined by the folder information, and the folder ID repository node 104 identifies 1504 one of the folders of applications that satisfies the search criteria. The folder ID repository node 104 communicates 1506 a list of the applications within the identified one of the folders of applications, to the one of the user terminals 120.

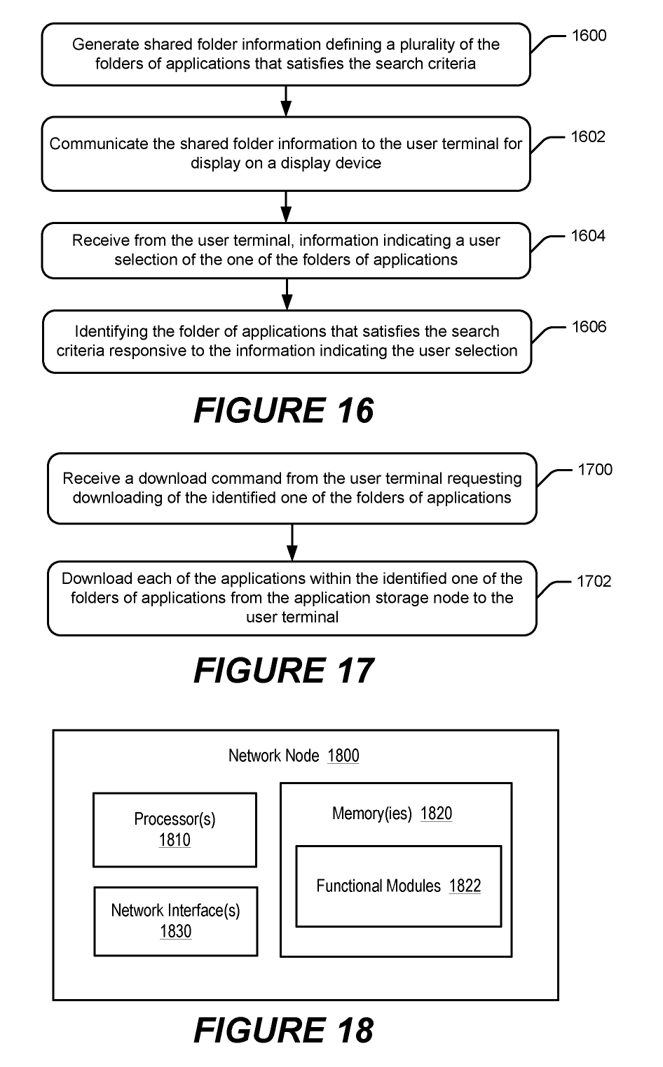

Referring to the further embodiment of FIG. 16, shared folder information defining a plurality of the folders of applications that satisfies the search criteria is generated 1600. The shared folder information is communicated 1602 to the one of the user terminals 120 for display on the display device 136. Information indicating a user selection of the one of the folders of applications is received 1604 from the one of the user terminals (120), and the one of the folders of applications that satisfies the search criteria responsive to the information indicating the user selection is identified 1606.

Referring to the further embodiment of FIG. 17, the at least one node further includes the application storage node 102 that stores applications. The folder ID repository node 104 receives 1700 a download command from the one of the user terminals 120 requesting downloading of the identified one of the folders of applications, and downloads 1702 each of the applications within the identified one of the folders of applications from the application storage node 102 to the one of the user terminals 120.

Example Network Node:

FIG. 18 is a block diagram of an example network node 18, which may be used for the application storage node 102, the folder ID repository node 14, and/or the social media service network node 106. The network node 1800 can include a network interface 1830, a processor 1810, and a memory 1820 that contain functional modules 1822. The processor 1810 may include one or more data processing circuits, such as a general purpose and/or special purpose processor (e.g., microprocessor and/or digital signal processor), which may be collocated or distributed across one or more data networks (e.g., network 110). The processor 1810 is configured to execute computer program instructions from the functional modules 1822 in the memory 1820, described below as a computer readable medium, to perform some or all of the operations and methods that are described above for one or more of the embodiments disclosed herein, such as the embodiments of FIGS. 1-17.

Further Definitions and Embodiments:

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” or “/” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the non-transitory computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. A method by a user terminal for managing applications executable by the user terminal, the method comprising the steps of:
generating folder information that defines folders of the applications;
generating action rule information that defines, for each of the folders of applications, an action to be performed on the folder of applications and a rule that initiates performance of the action;
determining that a first one of the rules is satisfied;
selecting a first one of the folders of the applications associated with the satisfied first one of the rules;
identifying applications missing from a memory of the user terminal that are members of the selected first one of the folders of the applications; and
downloading the identified applications from an application storage node via a network to the memory of the user terminal.

2. The method of claim 1, further comprising the step of:
communicating the folder information to a folder identification, ID, repository node via the network based on the generating; and
wherein the step of identifying applications missing from the memory of the user terminal that are members of the selected first one of the folders of the applications, comprises:
retrieving from the folder ID repository node via the network, a first list of applications that are members of the selected first one of the folders of the applications; and
comparing the first list of applications to applications residing in the memory of the user terminal to identify applications missing from the memory of the user terminal that are members of the selected first one of the folders of the applications.

3. The method of claim 2, further comprising the steps of:
generating a message containing an address link used to retrieve of-at least a portion of the folder information from the folder ID repository node; and
communicating the message to other user terminals and/or posting the message on a social media service network node for retrieval by other user terminals.

4. The method of claim 2, further comprising the steps of:
querying the folder ID repository node to obtain folder information that defines a second folder of the applications, that was provided to the folder ID repository node by another user terminal for sharing with other users of the folder ID repository node, and that satisfies a search criteria defined by the user terminal;
identifying applications missing from the memory of the user terminal that are members of the second folder of the applications; and
downloading, via the network to the memory of the user terminal, the applications identified as missing from the memory of the user terminal that are members of the second folder of the applications.

5. The method of claim 4, further comprising the step of:
adding to the action rule information, a second rule for the second folder of the applications that defines an event that will initiate deletion of the second folder of the applications from the memory of the user terminal;
determining that the second rule is satisfied by occurrence of the event; and
deleting the second folder of the applications from the memory of the user terminal.

6. The method of claim 4, wherein the step of querying the folder ID repository node to obtain folder information that defines the second folder of the applications, comprises:
receiving, from the folder ID repository node, shared folder information defining a plurality of folders of applications that were provided to the folder ID repository node by one or more other user terminals and which satisfy the search criteria;
displaying, on a display device of the user terminal, the shared folder information; and
receiving, via a user interface of the user terminal, a user selection of the second folder of the applications among other folders of the applications defined by the shared folder information.

7. The method of claim 2, further comprising the steps of:
determining that a third one of the rules is satisfied;
selecting a third one of the folders of the applications associated with the satisfied third one of the rules;
retrieving, from the folder ID repository node via the network, a third list of applications that are members of the selected third one of the folders of the applications;
comparing the third list of applications to applications residing in the memory of the user terminal to identify further applications missing from the memory of the user terminal that are members of the selected third one of the folders of the applications; and
downloading the identified further applications from the application storage node via the network to the memory of the user terminal.

8. The method of claim 1, further comprising the steps of:
determining that a fourth one of the rules is satisfied, wherein the fourth one of the rules defines an event that will initiate deletion of the first one of the folders of the applications from the memory of the user terminal; and
deleting applications of the selected first one of the folders of the applications from the memory of the user terminal responsive to the satisfied fourth one of the rules.

9. The method of claim 1, wherein:
the first one of the rules defines a geographic area; and
the step of determining that the first one of the rules is satisfied, comprises determining that the user terminal has moved to the geographic area.

10. The method of claim 8, wherein:
the fourth one of the rules defines an elapsed time; and
the step of determining that the fourth one of the rules is satisfied, comprises determining that the elapsed time has elapsed since the first one of the folders of the applications was downloaded from the application storage node to the memory of the user terminal.

11. The method of claim 8, wherein:
the fourth one of the rules defines a geographic area; and
the step of determining that the fourth one of the rules is satisfied, comprises determining that the user terminal has returned to the geographic area after being determined to have left the geographic area.

12. A user terminal comprising:
at least one processor; and
at least one memory coupled to the at least one processor and comprising computer readable program code embodied in the at least one memory that when executed by the at least one processor causes the at least one processor to perform operations comprising:
generating folder information that defines folders of the applications;
generating action rule information that defines, for each of the folders of applications, an action to be performed on the folder of applications and a rule that initiates performance of the action;
determining that a first one of the rules is satisfied;
selecting a first one of the folders of the applications associated with the satisfied first one of the rules;
identifying applications missing from a memory of the user terminal that are members of the selected first one of the folders of the applications; and
downloading the identified applications from an application storage node via a network to the memory of the user terminal.

13. The user terminal of claim 12, wherein the operations further comprise:
communicating the folder information to a folder ID repository node via the network based on the generating; and
wherein the operation of identifying applications missing from the memory of the user terminal that are members of the selected first one of the folders of the applications, comprises:
retrieving from the folder ID repository node via the network, a first list of applications that are members of the selected first one of the folders of the applications; and
comparing the first list of applications to applications residing in the memory of the user terminal to identify applications missing from the memory of the user terminal that are members of the selected first one of the folders of the applications.

14. The user terminal of claim 12, wherein the operations further comprise:
generating a message containing an address link used to retrieve of at least a portion of the folder information from the folder ID repository node; and
communicating the message to other user terminals and/or posting the message on a social media service network node for retrieval by other user terminals.

15. The user terminal of claim 12, wherein the operations further comprise:
querying the folder ID repository node to obtain folder information that defines a second folder of the applications, that was provided to the folder ID repository node by another user terminal for sharing with other users of the folder ID repository node, and that satisfies a search criteria defined by the user terminal;
identifying applications missing from the memory of the user terminal that are members of the second folder of the applications; and
downloading, via the network to the memory of the user terminal, the applications identified as missing from the memory of the user terminal that are members of the second folder of the applications.

16. The user terminal of claim 15, wherein the operations further comprise:
adding to the action rule information, a second rule for the second folder of the applications that defines an event that will initiate deletion of the second folder of the applications from the memory of the user terminal;
determining that the second rule is satisfied by occurrence of the event; and
deleting the second folder of the applications from the memory of the user terminal.

17. The user terminal of claim 15, wherein the operation of querying the folder ID repository node to obtain folder information that defines the second folder of the applications, comprises:
receiving, from the folder ID repository node, shared folder information defining a plurality of folders of applications that were provided to the folder ID repository node by one or more other user terminals and which satisfy the search criteria;
displaying, on a display device of the user terminal, the shared folder information; and
receiving, via a user interface of the user terminal, a user selection of the second folder of the applications among other folders of the applications defined by the shared folder information.

18. A method by at least one network node, which includes a folder ID repository node of a distributed computing system, for managing which applications are downloaded to user terminals, the method comprising the steps of:
receiving folder information via the network from a plurality of user terminals, wherein the folder information defines folders of applications that the user terminals can select among for downloading;
receiving a query from one of the user terminals that identifies a search criteria for searching among the folders of applications defined by the folder information;
identifying one of the folders of applications that satisfies the search criteria; and
communicating a list of the applications within the identified one of the folders of applications, to the one of the user terminals.

19. The method of claim 18, wherein the step of identifying one of the folders of applications that satisfies the search criteria, comprises:
generating shared folder information defining a plurality of the folders of applications that satisfies the search criteria;
communicating the shared folder information to the one of the user terminals for display on a display device;
receiving from the one of the user terminals, information indicating a user selection of the one of the folders of applications; and
identifying the one of the folders of applications that satisfies the search criteria responsive to the information indicating the user selection.

20. The method of claim 18, wherein the at least one node further comprises an application storage node that stores applications, and further comprising the steps of:
receiving a download command from the one of the user terminals requesting downloading of the identified one of the folders of applications; and
downloading each of the applications within the identified one of the folders of applications from the application storage node to the one of the user terminals.
